(19) United States
(12) Patent Application Publication
(10) Pub. No.: US 2011/0099742 A1
(43) Pub. Date: May 5, 2011

(54) Heated Ice Scraper

(75) Inventor: Aku Venäläinen, Nilsia (FI)

(73) Assignee: Hot Edge Oy

(21) Appl. No.: 12/995,254

(22) PCT Filed: Feb. 26, 2009
(86) PCT No.: PCT/FI09/50160

§ 371 Date: Jan. 20, 2011

(30) Foreign Application Priority Data
May 30, 2008 (FI) 20085518

(51) Int. Cl. A47L 13/02; H05B 1/02

(52) U.S. Cl. 15/236.02; 219/241

(57) ABSTRACT

The invention relates to a heated ice scraper, comprising a blade unit (1) for scraping ice from a surface, and a heating unit (3) including a power source (4) operatively connected to a heating element (5) that is in contact with the blade unit (1) for at least partly heating the blade unit (1). The heating element (5) comprises a film resistor that is in contact with the blade unit (1) for at least partly heating the blade unit (1).

### FIELD OF THE INVENTION

The invention relates to a heated ice scraper as defined in the preamble of independent claim 1.

The invention relates especially to a heated ice scraper for removing ice from the windows especially the windscreen of motor vehicles.

Heated ice scrapers are known in the prior art, for example from publications U.S. Pat. No. 5,357,646, U.S. Pat. No. 5,973,294 and EP 1 199 021 A2.

Publication EP 1 199 021 A2 discloses a heated ice scraper as defined in the preamble of independent claim 1.

### OBJECTIVE OF THE INVENTION

The object of the invention is to provide a new and inventive type of heated ice scraper having a better distribution of heat transferred from the heating element to the blade unit.

### SHORT DESCRIPTION OF THE INVENTION

The heated ice scraper of the invention is characterized by the definitions of independent claim 1.

Preferred embodiments of the heated ice scraper are defined in the dependent claims.

The invention is based on the use of a film resistor, a foil heater or a similar heater in the form of a film for heating the blade unit.

Using of a film resistor, a foil heater or a similar heater in the form of a film provides for evenly distributed thermal energy in the blade unit for example in comparison with resistors of wire type, which only transfers thermal energy to a point of the blade unit from which the heat is distributed to the rest of the blade unit. The heating element, that is the film resistor, the foil heater or the similar heater in the form of a film for heating the blade unit, is preferably at least partly inside the blade unit. In a preferred embodiment of the invention the heating element is totally inside the blade unit, the blade unit then comprising a heating element as a core of the blade unit and blade unit material surrounding the core. The benefit of the heating element being inside the blade unit is the blade unit becoming warm quickly.

In a preferred embodiment of the invention a rechargeable power source such as a rechargeable battery or accumulator is used for supplying electrical energy to the heating element. The rechargeable battery or accumulator can be of the type which is to be charged via an electrical cable to the cigarette lighter of a motor vehicle or it can be charged with a normal battery charger of the type used for mobile phones. In another preferred embodiment of the invention there is a rack with a battery charger apparatus in the motor vehicle where the ice scraper is kept while it is not used and at the same time it charges the battery or accumulator so that the battery or accumulator is charged when the ice scraper is needed the next time. The idea of using a rechargeable battery or an accumulator in the ice scraper is that it makes the use of ice scraper easier when there is no wire hanging and the blade unit can still be heated when used. The benefit of the rechargeable battery is that it is easy and quick to charge.

In a preferred embodiment of the invention a heating element comprising a material having a positive thermal coefficient (PTC) effect is used. Using of a material having a positive thermal coefficient (PTC) effect makes possible that when the blade unit comes in contact with ice and the temperature of the heating element consequently decreases, the heating energy output of the heating element is automatically increased so that the original temperature of the heating element and consequently the original temperature of the blade unit does not essentially change.

In a preferred embodiment of the invention, when using the ice scraper, a temperature controller or a thermostat is arranged keeping the temperature of the blade unit between certain minimum and maximum temperatures, for example preferably between 90° C. and 99° C. A sensor is arranged for measuring the temperature in the blade unit and when the blade unit becomes warmer than the specified maximum temperature the temperature controller or the thermostat switches off the power. When the heating element becomes colder than the specified minimum temperature the temperature controller or the thermostat switches on the power. The temperature levels can be adjusted.

The invention relates also to a motor vehicle comprising a heated ice scraper according to any of the claims 1 to 10 detachable arranged in the motor vehicle.

### LIST OF FIGURES

In the following the invention will be described in more detail by referring to the figures, of which

FIG. 1 shows a preferred embodiment of the heated ice scraper,

FIG. 2 shows the heated ice scraper shown in FIG. 1 in side view,

FIG. 3 shows the heated ice scraper shown in FIGS. 1 and 2 in cross section along line A-A shown in FIG. 2,

FIG. 4 shows an other preferred embodiment of the heated ice scraper in a side view with a detail section from the blade unit,

FIG. 5 shows the heated ice scraper shown in FIG. 4 from the top side, and

FIG. 6 shows the heated ice scraper shown in FIG. 4 from the top side also.

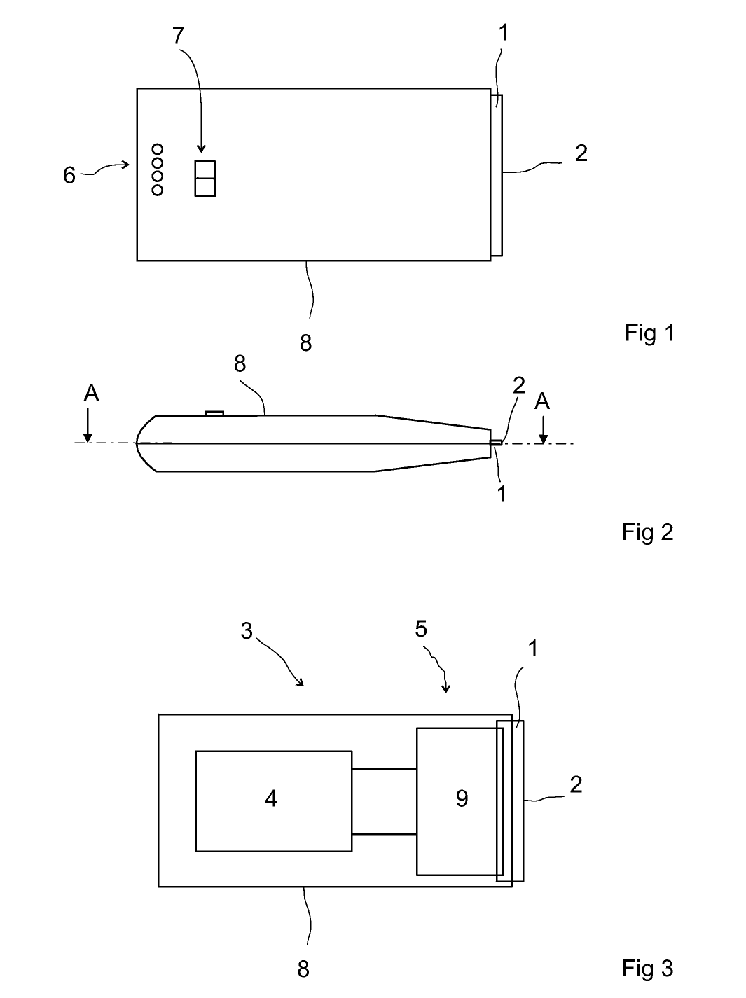

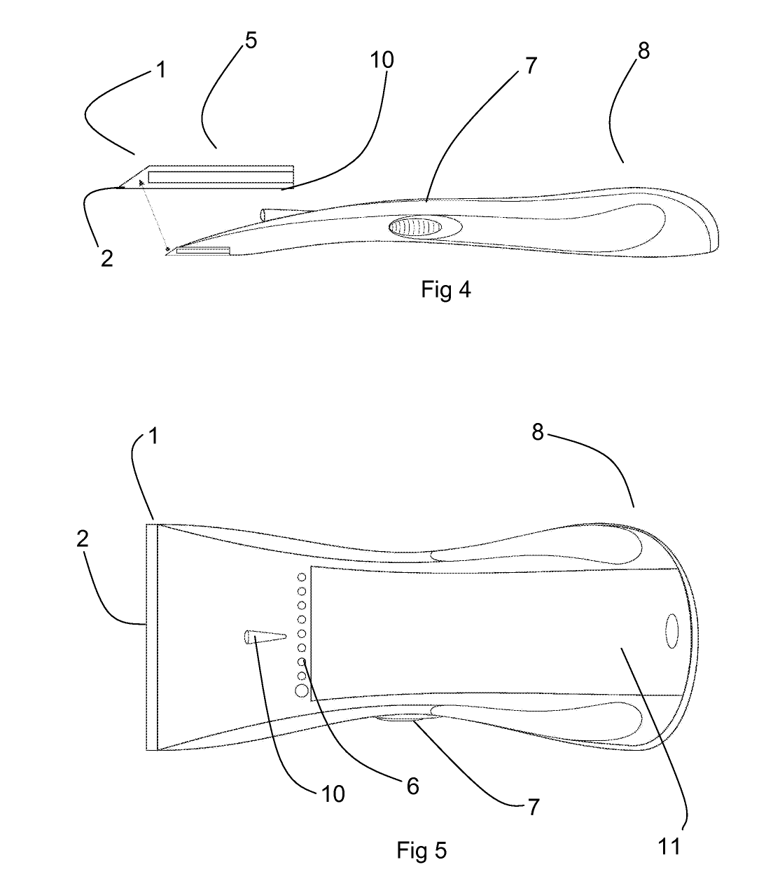

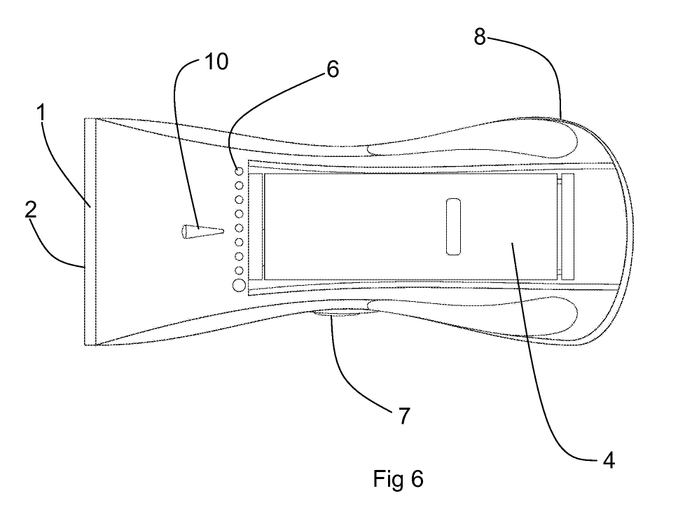

### DETAILED DESCRIPTION OF THE INVENTION

The figures show an example of a heated ice scraper.

The heated ice scraper comprises a blade unit 1 for scraping ice from a surface (not shown in the figure). The blade unit 1 includes a scraper edge 2.

The blade unit 1 is preferably, but not necessarily, at least partly formed of metal and/or polymer and/or ceramics. In a preferred embodiment the blade unit is formed of metal which is coated with polymer.

The heated ice scraper comprises a heating unit 3 including a power source 4 operatively connected to a heating element 5 that is in contact with the blade unit 1 for at least partly heating the blade unit 1. The power source 4 is configured for supplying electrical energy to the heating element 5.

The heating element 5 comprises a film resistor 9, a foil heater or a similar heater in the form of a film that is in contact with the blade unit 1 for at least partly heating the blade unit 1. Suitable heaters are for example, but not excluding other similar heaters, a Mica heater, a polymer heater, a polyamide heater, or a silicone rubber heater. The heater can also be a flexible polymer thick film resistor, which is custom made to a suitable size and shape. The heating element 5 comprises preferably a thermostat or a temperature controller functionally connected to the blade unit 1 to measure the temperature of the blade unit 1 when the ice scraper is in use. When the temperature of the blade unit exceeds some specified temperature for example 99° C. the thermostat switches off the power. When the temperature of the blade unit goes under a specified temperature for example 90° C. the thermostat switches on the power. The thermostat controls the temperature of the film resistor 9, a foil heater or a similar heater in the form of a film. When the blade unit 1 meets the ice, the blade unit 1 does not cool down but the thermostat gives more power to the film resistor 9 or similar. That way the temperature of the blade unit stays stable.

The power source 4 is preferably, but not necessarily, a rechargeable power source 4. Alternatively can the power source 4 be at least one battery.

If the heated ice scraper comprises a rechargeable power source 4, the heated ice scraper comprises preferably, but not necessarily, an indicator 6 for visually showing the charging level of the rechargeable power source 4.

The heating element 5 comprises preferably, but not necessarily, a material having a positive thermal coefficient (PTC) effect.

The heated ice scraper comprises preferably, but not necessarily, an on/off switch 7 for operatively connecting the heating element 5 with the power source 4 and correspondingly, for operatively disconnecting the heating element 5 from the power source 4. The on/off switch 7 is preferably such that it has to be pressed continuously when heating the blade unit 1. That way harmful accident may be avoided.

The heated ice scraper comprises preferably, but not necessarily, a housing 8 for housing at least the power source 4. The blade unit 1 forms in this embodiment of the invention preferably, but not necessarily, an integral part of the housing 8. Alternatively the blade unit 1 can be attached to the housing 8.

The housing 8 comprises preferably a cover piece 11 that covers the power source 4. The cover piece 11 can be coated with a material, e.g. rubber that helps the user to have a good grip of the ice scraper.

The heated ice scraper comprises preferably, but not necessarily a light 10 near the scraper edge 2. The light 10 is advantageously a LED light but can be other sort of light as well. The light 10 can be placed anywhere in the housing 8 in a place where it is able to give light to the object that is to be scraped.

It is apparent to a person skilled in the art that as technology advanced, the basic idea of the invention can be implemented in various ways. The invention and its embodiments are therefore not restricted to the above examples, but they may vary within the scope of the claims.

1-11. (canceled)

12. A heated ice scraper, comprising:
a blade unit for scraping ice from a surface, and
a heating unit, including a power source operatively connected to a heater having a form of a film that is in contact with the blade unit for at least partly heating the blade unit.

13. The heated ice scraper of claim 12, wherein the heater comprises a temperature controller functionally connected to the blade unit to measure a temperature of the blade unit.

14. The heated ice scraper of claim 13, wherein the power source is a rechargeable power source.

15. The heated ice scraper of claim 14, further comprising an indicator that visually shows a charge level of the rechargeable power source.

16. The heated ice scraper of claim 12, wherein the heater comprises a material having a positive thermal coefficient (PTC).

17. The heated ice scraper of claim 12, further comprising an on/off switch for operatively connecting and disconnecting the heater and the power source.

18. The heated ice scraper of claim 12, wherein the blade unit is at least partly formed of at least one of metal and a polymer material.

19. The heated ice scraper of claim 12, further comprising a housing that houses at least the power source.

20. The heated ice scraper of claim 19, wherein the blade unit is an integral part of the housing.

21. The heated ice scraper of claim 19, wherein the blade unit is attached to the housing.

22. The heated ice scraper of claim 12, wherein the heated ice scraper is configured for detachable attachment to a motor vehicle.

23. A heated ice scraper, comprising:
a blade unit for scraping ice from a surface,
a heating unit, including a power source operatively connected to a heater having a form of a film that is in contact with the blade unit for at least partly heating the blade unit, and
a housing that houses at least the power source,
wherein the heater comprises a temperature controller functionally connected to the blade unit to measure a temperature of the blade unit, and the blade unit is at least partly formed of at least one of metal and a polymer material.

24. The heated ice scraper of claim 23, wherein the power source is a rechargeable power source.

25. The heated ice scraper of claim 24, further comprising an indicator that visually shows a charge level of the rechargeable power source.

26. The heated ice scraper of claim 23, wherein the blade unit is an integral part of the housing.

27. The heated ice scraper of claim 23, wherein the blade unit is attached to the housing.

28. The heated ice scraper of claim 23, wherein the heated ice scraper is configured for detachable attachment to a motor vehicle.
